(19) United States
(12) Patent Application Publication
(10) Pub. No.: US 2022/0103375 A1
(43) Pub. Date: Mar. 31, 2022

(54) POST-QUANTUM SIGNATURE SCHEME USING BIOMETRICS OR OTHER FUZZY DATA

(71) Applicant: Oxford University Innovation Limited, Oxford (Oxfordshire) (GB)

(72) Inventors: Ali EL KAAFARANI, Oxford (Oxfordshire) (GB); Shuichi KATSUMATA, Oxford (Oxfordshire) (GB)

(21) Appl. No.: 17/426,123

(22) PCT Filed: Jan. 31, 2020
(86) PCT No.: PCT/GB2020/050238

§ 371 Date: Jul. 28, 2021

(30) Foreign Application Priority Data
Feb. 1, 2019 (GB) 1901447.1

(51) Int. Cl. H04L 9/32; H04L 9/14; H04L 9/00

(52) U.S. Cl. CPC H04L 9/3247; H04L 9/008; H04L 9/14

(57) ABSTRACT

Cryptographic methods and systems are described. An example cryptographic system may include a signature engine to digitally sign a message using fuzzy data associated with a signee. The signature engine is configured to generate a digital signature using a lattice instantiation and a linear sketch. The linear sketch is configured based on the lattice instantiation. The digital signature is a function of the fuzzy data and the message and uses a signature-time signing key residing within a signing key space. The signing key space is a space defined by the lattice instantiation. An example of a verification engine is also described. The verification engine is configured to receive the message and the digital signature and to verify the message as signed by the signee. The verification engine is configured to obtain key data for the signee comprising at least an initialisation-time verification key, to compute a distance metric based on the key data and the received digital signature, the distance metric indicating a measure of difference for the signature-time verification key, and to indicate a verification failure responsive to the distance metric being greater than a predefined homomorphic threshold. The methods and systems may be used as an authentication mechanism.

### TECHNICAL FIELD

The present invention relates to cryptographic methods and systems. In particular, the present invention relates to digital signature configurations based on fuzzy data inputs. The methods and systems may be used to authenticate a user and enable secure communications between two computing devices.

### BACKGROUND

Public key cryptography has a significant role in enabling secure communication between digital devices. For example, public key cryptography underlies modern e-commerce, secure messaging, online banking and access to remote computing systems. In many cryptographic schemes, a user is provided with a private key and a public key. The private key is kept secret and may be used to sign digital messages. The public key may be disseminated widely and then be used to verify that a message has been signed using the private key. In this way, the pair of keys enable a user to be authenticated by verifying messages as originating from the user.

One problem with public key cryptographic systems is that a user needs to securely store their private key. In many cases, the private key is stored within a storage medium of an electronic device, such as a smart card or a Universal Serial Bus (USB) device. To digitally sign a message the user couples the electronic device to a computing device, e.g. inserts a smart card into a reader or plugs in a USB device. The computing device is then able to access the private key. Alternatively, a private key may be stored in a secure memory of a particular computing device, such as a smartphone. However, even in this case, the user still requires the particular computing device to perform cryptographic operations. These systems provide an obstacle to wide adoption of cryptographic methods, especially for user groups such as the elderly.

One suggested solution to the problem of requiring access to a private key is to use biometric data. For example, measurements may be made of a user's face, fingerprint or iris and these measurements may be used in cryptographic methods. Such a system could allow a user to pay at a point of sale terminal with their finger or authorise online transactions with their face. However, these approaches have been limited by the inherent variability of these measurements: the data is noisy and fluctuates each time a measurement is made. In certain cryptographic systems this data is referred to as “fuzzy” data.

Fuzzy data provides an obstacle to using biometric data as signing keys. For example, assume a user prepares a verification key vk_{FS} where the corresponding signing key is her fingerprint x. When the user wants to sign a message, she will use her fingerprint as the signing key. However, due to measurement errors, she will only be able to reproduce a fingerprint x′ that is “close” to the original x which was used during key registration. Therefore, even if a signature is generated using x′ as the signing key, it will not verify against vk_{FS} that was generated with x. To attempt to get around this problem, certain cryptographic methods assumed that the signers can use additional help, such as access to an online server during signing or access to an offline token or electronic device. However, these methods suffer from the problems that biometric data was deemed to solve.

Takahashi et al, in their paper “Signature Schemes with a Fuzzy Private Key”, published in the Cryptology ePrint Archive, Report 2017/1188, 2017, describe a fuzzy signature scheme that operates on noisy strings such as biometric data. They describe two approaches that do not require user-specific auxiliary data to generate a digital signature, such as a helper string in the context of fuzzy extractors. They introduce a tool called a “linear sketch”, which they describe as operating somewhat similar to a one-time pad encryption scheme. They then present two concrete instantiations of their fuzzy signature scheme.

While the approach described by Takahashi advances the field of cryptographic methods, it has a disadvantage that it is open to an attack by a quantum computer. For many years, quantum computers were of mainly theoretical interest. However, recent work has shown that many well-known public key cryptographic systems can be broken by a sufficiently strong quantum computer. Research implementations of quantum computers are also developing rapidly. Quantum computers having 50 and 72 qubits are currently available, and there are many research groups actively working on higher qubit machines.

It is thus desirable to provide cryptographic solutions that avoid the common problems of public key cryptography, while being resistant to attack in a post-quantum environment.

### SUMMARY

Aspects of the present invention are set out in the appended independent claims. Certain variations of the invention are then set out in the appended dependent claims.

### BRIEF DESCRIPTION OF THE DRAWINGS

Examples of the invention will now be described, by way of example only, with reference to the accompanying drawings, in which:

FIG. 1A is a schematic illustration showing a cryptographic system for digitally signing a message according to an example;

FIG. 1B is a schematic illustration showing a cryptographic system for verifying a message according to an example;

FIG. 2 is a schematic illustration showing a cryptographic system for digitally signing and verifying a message according to an example;

FIG. 3 is a schematic illustration showing a cryptographic system for digitally signing a message according to another example;

FIG. 4A is a schematic illustration showing a signing device for a cryptographic system according to an example;

FIG. 4B is a schematic illustration showing a verification device for a cryptographic system according to an example;

FIGS. 4C and 4D are a schematic illustration showing components of example cryptographic devices;

FIGS. 5A to 5C are a set of flow charts showing example cryptographic methods that use fuzzy data;

FIGS. 6A to 6C are flow diagrams respectively showing examples of a key generation process, a digital signature process and a verification process; and

FIGS. 7A to 7D are illustrated pseudo-code formulations showing cryptographic functions for a cryptographic method according to an example.

### DETAILED DESCRIPTION

Certain examples described herein provide cryptographic methods and systems that are secure against an attack by a quantum computer, i.e. that provide so-called post-quantum solutions. Certain examples provide this security by generating a digital signature using a lattice instantiation, e.g. an instance of lattice-based cryptography. These examples further overcome problems that arise when implementing lattice-based cryptography with fuzzy data sources. To do this a fuzzy signature scheme is presented that uses linear sketches that are compatible with the lattice instantiation. This fuzzy signature scheme may be used to implement electronic devices for the signing and verification of digital messages. The fuzzy signature scheme may also be used to implement devices that ensure data integrity and/or user authenticity. These electronic devices may then be used to authenticate a user based on fuzzy data associated with the user, such as a biometric measurement. Certain example systems and methods thus enable biometric authentication without the use of helper devices or tokens that is also secure in a post-quantum environment. Certain examples described herein may be used in the place of existing digital signature schemes to provide improved security and/or biometric integration.

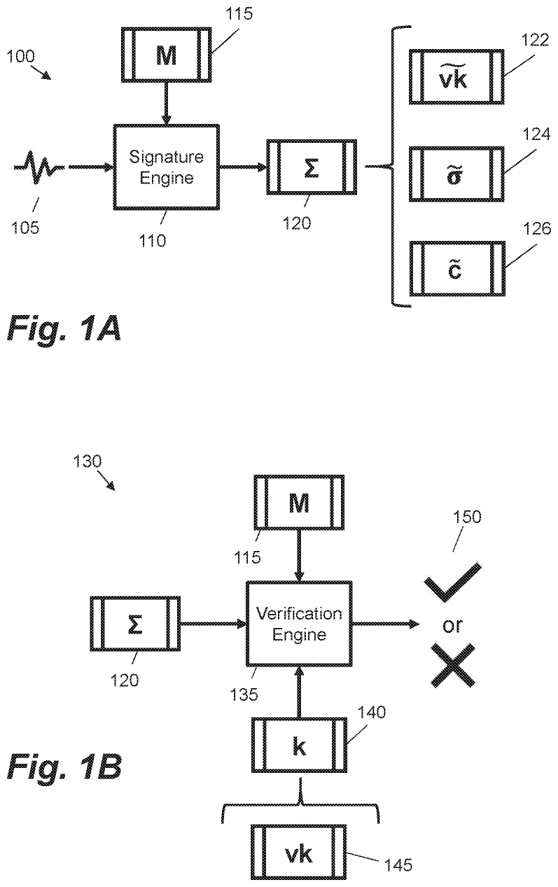

FIG. 1A shows a cryptographic system 100 according to an example. The cryptographic system 100 may form part of an electronic device, a communications terminal or a biometric reader. The cryptographic system 100 is configured to operate on fuzzy data 105. Fuzzy data 105 comprises data that varies across a data distribution. For example, fuzzy data 105 may comprise an array of data values, and each data value may be a real number stored within a defined data format. Fuzzy data 105 may be derived from sensor measurements and/or captured images. The fuzzy data 105 is received by a signature engine 110, along with a message 115. The message 115 may comprise a digital message in the form of a sequence of symbols selected from a predefined alphabet. In certain cases, this alphabet may comprise the symbols ‘0’ and ‘1’ and the message 115 may comprise a bit stream. The bit stream may represent string data, a data file, or other digital data. The message 115 may comprise digital data that is signed to ensure the integrity of the data, e.g. that the digital data is not modified by a malicious party. The signature engine 110 uses the fuzzy data 105 to digitally sign the message 115 on behalf of a signee. The signee may comprise a user who is the source of the fuzzy data 105. The signature engine 110 is configured to use the fuzzy data 105 and the message 115 to generate a digital signature 120.

In the example of FIG. 1A, the signature engine 110 is configured to generate the digital signature 120 using a lattice instantiation and a linear sketch function, where the linear sketch function is configured based on the lattice instantiation, i.e. the linear sketch is lattice compatible. The lattice instantiation uses a lattice-based computation to generate at least one component of the digital signature 120, Δn n-dimensional lattice is any discrete additive subgroup of [symbol] ⁿ. For any basis of [symbol] ⁿ, the subgroup of all linear combinations with integer coefficients of the basis vectors forms a lattice. Lattices may be defined within any finite-dimensional vector space over any field. A lattice-based computation may be seen as a computation or function that makes use of lattices. The lattice-based computation generates a lattice digital signature sigma, i.e. signature data that results from a defined lattice digital signature scheme. In one case, the lattice-based computation may comprise a Learning With Errors (LWE) computation. In other cases, other lattice-based digital signature schemes may be used.

In FIG. 1A, the digital signature 120 is computed as a function of the fuzzy data 105 and the message 115. The digital signature 120 comprises a signature-time verification key 122, the lattice digital signature sigma 124 from the lattice-based computation and the linear sketch 126. The signature engine 110 generates the digital signature 120 using a signature-time signing key that resides within a signing key space. For example, one or more of the signature-time verification key 122, the lattice digital signature sigma 124 and the linear sketch 126 may be generated as a function of the signature-time signing key. In one case, the signature-time verification key 122 is generated using a key generator. The key generator may form part of the lattice instantiation, e.g. form part of a lattice digital signature scheme. The signing key space may be predefined to have certain properties. In the present example, the signing key space is a space defined by the lattice instantiation. The linear sketch may comprise a function of the fuzzy data 105 and the signature-time signing key, such as a linear sum. The linear sketch may be seen as an encoding of the signature-time signing key, which is secret, using the fuzzy data as an encoding key. The function used to generate the linear sketch may use a defined hash function to generate a result. Details of an example linear sketch implementation are described in the aforementioned paper by Takahashi et al, the contents of which are incorporated by reference herein.

FIG. 1B also shows a cryptographic system 130 according to an example. The cryptographic system 130 of FIG. 1B and the cryptographic system 100 of FIG. 1A may form part of a common cryptographic system or may be implemented as separate systems. In FIG. 1B, the cryptographic system 130 operates on the message 115 and the digital signature 120. In FIG. 1B, the message 115 may comprise the message 115 of FIG. 1A or a digital copy of the message 115. The message 115 may be received together with the digital signature 120, received separately, and/or obtained from an accessible data storage device. The digital signature 120 in FIG. 1B is computed by a cryptographic system such as the cryptographic system 100 of FIG. 1A.

The cryptographic system 130 comprises a verification engine 135. The verification engine 135 is configured to receive the message 115 and the digital signature 120 and to verify the message as signed by the signee. The cryptographic system 130 may be used to authenticate the signee and/or ensure the data integrity of the message 115, e.g. following transmission over a communications channel. The verification engine 135 is configured to obtain key data 140 for the signee comprising at least an initialisation-time verification key 145. The initialisation-time verification key 145 may differ from the signature-time verification key 124 that was used to generate the digital signature data 122. The initialisation-time verification key 145 may be generated by a key generator in a process that is performed at a different time to a process performed by the signature engine 110. The key generator may be the same key generator as used for the signature engine 110, e.g. may apply the same key generation function but with different values for one or more variables. In one case, the initialisation-time verification key 145 may be generated using an initialisation-time signing key that is sampled from a signing key space. The initialisation-time verification key 145 may be generated as part of a registration process, e.g. a key initialisation process. In one case, the key data 140 may comprise a linear sketch that is generated with the initialisation-time verification key, wherein the initialisation-time verification key 145 and the initialisation-time linear sketch comprise respective functions of a secret initialisation-time signing key. As before, the initialisation-time linear sketch may comprise a function of fuzzy data measured at the initialisation time and the secret initialisation-time signing key. The verification engine 135 may retrieve the initialisation-time verification key 145 from an accessible key store, e.g. in the form of a database entry that is indexed by the signee. The signee may be identified in the message 115 or the digital signature 120.

The verification engine 135 is configured to compute a distance metric based on the key data 140 and the received digital signature 120. The distance metric indicates a measure of difference for the signature-time verification key 124. For example, the distance metric may indicate a distance between the signature-time verification key 124 and the initialisation-time verification key 145. The verification engine 135 is configured to output an indication of verification success or failure 150. In the present example, the verification engine 135 is configured to indicate a verification failure responsive to the distance metric being greater than a predefined homomorphic threshold. In certain cases, the predefined homomorphic threshold is non-zero. There may be additional conditions that are to be met for the verification engine 135 to indicate a verification success. For example, the verification engine 135 may attempt to verify the lattice digital signature sigma 124. This may comprise computing a first digest using a first set of components of the lattice digital signature sigma 124, the message 115 and the signature-time verification key 122 and comparing this with a second digest forming another component of the lattice digital signature sigma 124. The linear sketch 126 within the received digital signature 120 may be used together with the key data 140 to generate a reconstructed verification key. The distance metric may indicate a measure of difference between the signature-time verification key and the reconstructed verification key. If the distance metric is greater than the predefined homomorphic threshold and/or if the verification of the lattice digital signature sigma 124 fails, then the verification engine 135 may indicate a verification failure.

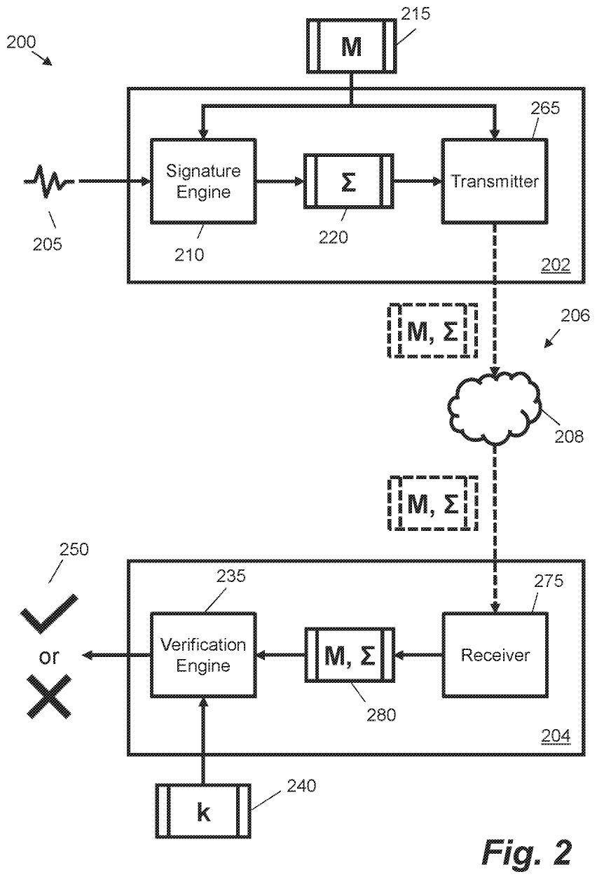

FIG. 2 shows a cryptographic system 200 comprising a first terminal 202 and a second terminal 204. The first terminal forms a signing device. The second terminal forms a verifying device. The two terminals are communicatively coupled by a communications channel 206. The communications channel may comprise one or more network connections 208 using any suitable physical media, including wired and wireless interfaces.

The first terminal 202 is similar to the cryptographic system 100 of FIG. 1A. Components with similar functionality are labelled with reference to the numerals of FIG. 1A. The first terminal 202 receives fuzzy data 205. The first terminal 202 comprises a signature engine 210 that receives the fuzzy data 205 together with message 215. The signature engine 210 is configured to process the fuzzy data 205 and the message 215 to generate a digital signature 220. The signature engine 210 may generate the digital signature 220 in a similar manner to the signature engine 110 of FIG. 1A.

The first terminal 202 also comprises a transmitter 265. The transmitter 265 is configured to receive the digital signature 220 from the signature engine 210 and the message 215 and then to transmit this data across the communications channel 206 to the second terminal 204. The transmitter 265 may transmit the digital signature 220 and the message 215 as a common data package and/or may transmit these data items separately. In other examples, the message 215 may not need to be transmitted by the transmitter 265, e.g. a copy of the message 215 may be available at both the first terminal 202 and the second terminal 204.

The second terminal 202 is similar to the cryptographic system 130 of FIG. 1B. The second terminal 204 comprises a verification engine 235 that is configured to receive key data 240 and output an indication of verification success or failure 250. The verification engine 235 may operate in a similar manner to the verification engine 135 of FIG. 1B. The second terminal 204 also comprises a receiver 275. In the present example, the receiver 275 receives a data package 280 comprising the message 215 and the digital signature 220 that has been transmitted across the communications channel 206. The data package 280 is received and processed by the verification engine 235, together with the key data 240, in order to output the indication of verification success or failure 250.

Many different authentication systems may use an arrangement similar to that shown in FIG. 2. For example, the first terminal 202 may comprise one or more of, amongst others, a biometric reader, a point-of-sale device, an automated teller machine, and a computing device (such as a desktop, laptop, smartphone or other mobile telephony device). The second terminal 204 may comprise a remote computing device to control access to a data resource or location, and/or a physical resource or location. The fuzzy data 205 may comprise biometric data such as an iris scan, a fingerprint scan and/or a face scan. The message 215 may comprise digital data such as the described sequence of bits. The cryptographic system 200 may be used to check the data integrity of the message 215 and/or to authenticate a user supplying the fuzzy data 205.

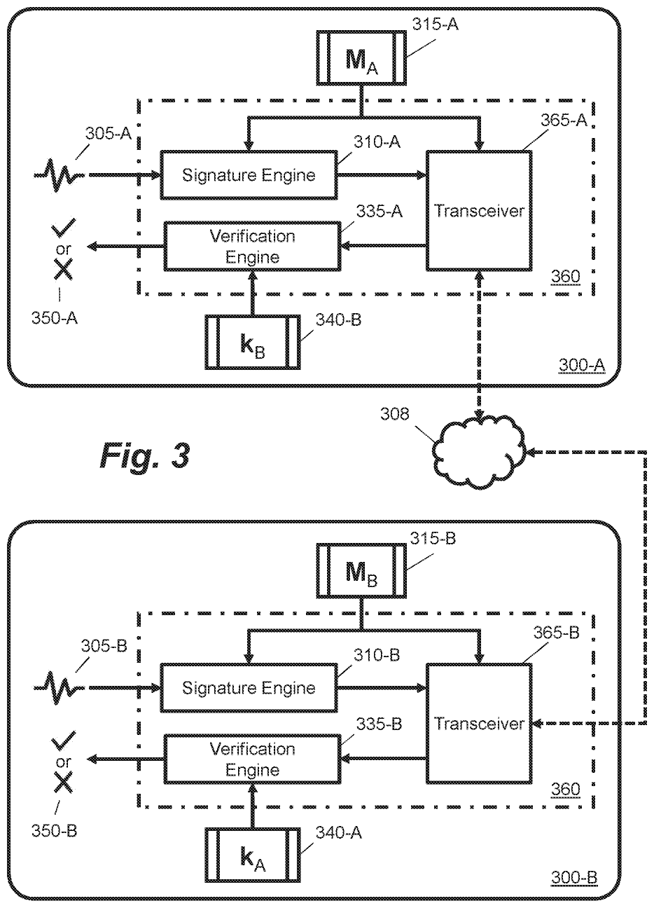

FIG. 3 shows an example of a first terminal 300-A and a second terminal 300-B that are configured to communicate over one or more networks. The two terminals 300-A, B may have a common, i.e. shared, configuration. For example, each terminal 300 may comprise a computing device such as a server, desktop, laptop, tablet or smartphone. In this example, the functionality of a signing device and a verification device are combined. Each terminal 300 thus comprises a signature engine 310 and a verification engine 335. Each terminal 300 further comprises a transceiver 365 to receive and transmit data. Although the transceiver 365 is shown as a single device it may comprise a separate receiver and transmitter in other examples. The signature engine 310, verification engine 335 and transceiver 365 may be implemented as a secure cryptographic module 360 within the terminal 300. For example, they may be implemented using secure electronic circuitry and/or computer program code arranged to be securely stored and processed by a processor. Secure electronic circuitry may be based on electronic circuitry such as a System-on-Chip (SoC), an Application-Specific Integrated Circuit (ASIC) or a Field Programmable Gate Arrays (FPGA). In one case, the signature engine 310 may be configured to securely access fuzzy data 305, e.g. using a secure coupling to a biometric sensor and the like, or by accessing a secure memory location.

The example of FIG. 3 shows how two users may send verifiable messages to each other. A first user prepares a first message 315-A using the first terminal 300-A. They then provide fuzzy data 305-A to sign the first message 315-A using the signature engine 310-A. The signature engine 310-A outputs a digital signature that is sent with the first message 315-A to the second terminal 300-B via the transceiver 365-A of the first terminal 300-A. The transceiver 365-B of the second terminal 300-B receives the transmitted data and passes it to the verification engine 335-B. The verification engine 335-B obtains key data for the first user 340-A and uses this to verify the received message 315-A, e.g. if the message is validly signed by the first user the indication 350-B will indicate the message is verified. In certain cases, a successful verification may be used to authenticate the first user, e.g. either with respect to the second terminal 300-B or a second user that is using the second terminal 300-B.

In FIG. 3 the process may also operate in the other direction. The second user may prepare a second message 315-B using the second terminal 300-B. The second user provides fuzzy data 305-B to sign the second message 315-B using the signature engine 310-B of the second terminal 300-B. The signature engine 310-B outputs a digital signature that is sent with the second message 315-B to the first terminal 300-A via the transceiver 365-B of the second terminal 300-B. The transceiver 365-A of the first terminal 300-A receives the transmitted data and passes it to the verification engine 335-A. The verification engine 335-A obtains key data for the second user 340-B and uses this to verify the received message 315-B, e.g. if the message is validly signed by the second user the indication 350-A will indicate the message is verified. In certain cases, a successful verification may be used to authenticate the second user, e.g. either with respect to the first terminal 300-A or the first user.

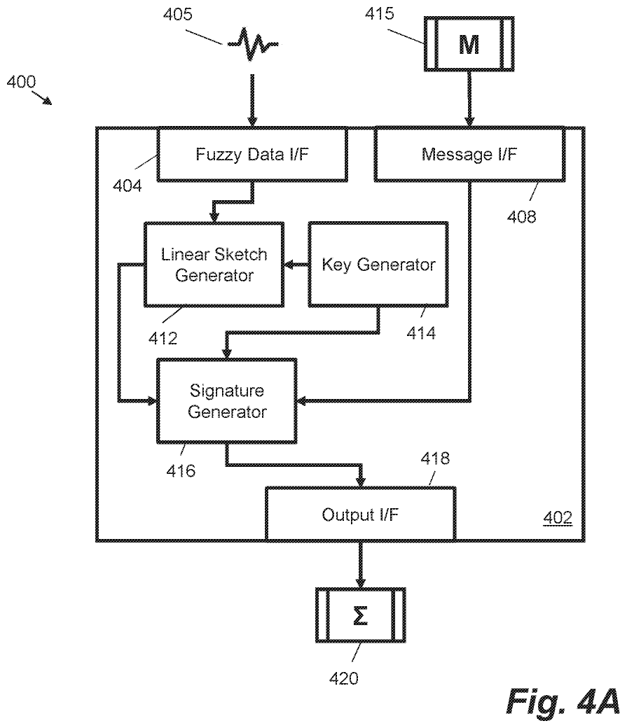

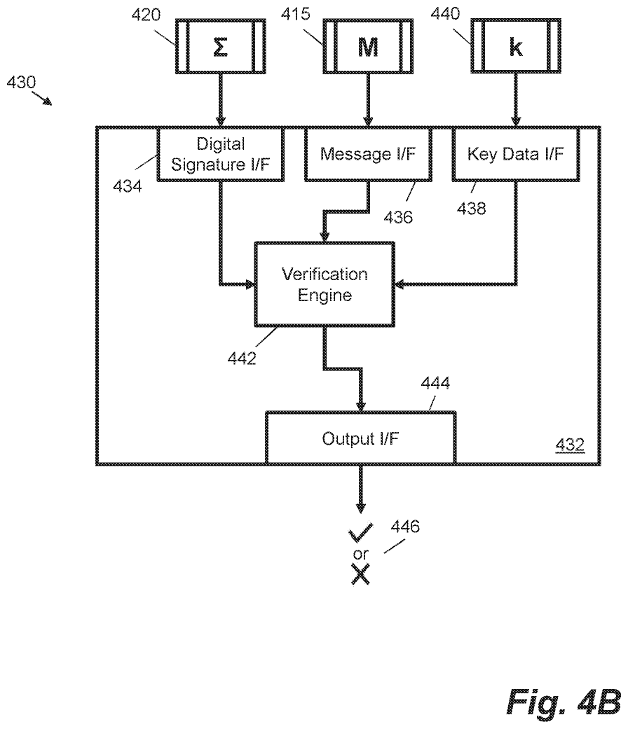

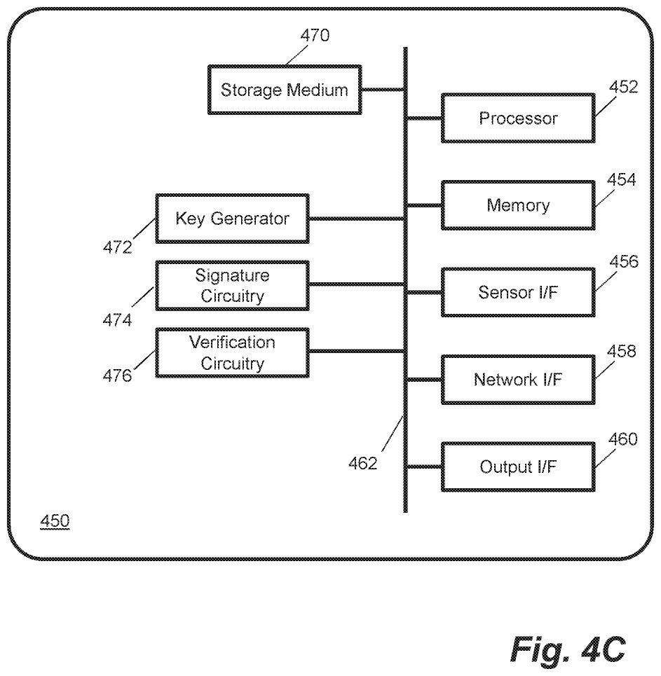

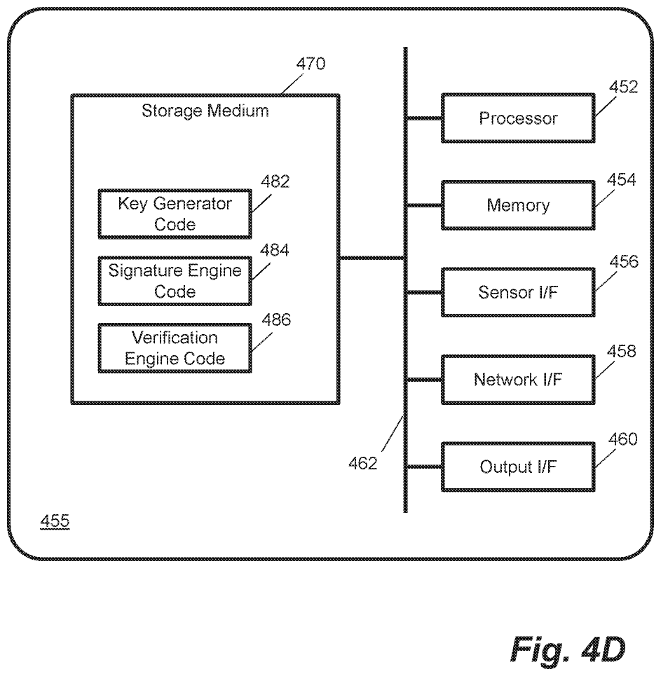

The operation of an example 400 of a signing device 402 will now be described with reference to FIG. 4A. The signing device 402 may be used as part of the cryptographic systems shown in FIGS. 1 to 3, e.g. to implement the signature engine 110, 210, 310.

The signing device 402 comprises a fuzzy data interface 404 to receive fuzzy data 405 associated with a signee and a message interface 408 to receive a message 415 for the signee to digitally sign. Each interface may comprise a specific hardware interface or be implemented using a general hardware interface. For example, the fuzzy data interface 404 may comprise a secure electrical coupling to a biometric sensor or the like and the message interface may comprise a systems bus coupling to a memory storing message data or a network interface that receives message data.

The signing device 402 also comprises a key generator 414 to generate a signature-time signing key and a signature-time verification key. These keys may comprise ephemeral or temporary keys that are only used for one signing operation. They may be distinguished from a signing key and a verification key that are generated at a separate initialisation stage. The key generator 414 may be configured to generate a separate set of signature-time keys for every signing operation. The signing keys may comprise private or secret keys that are only accessible to the key generator 414, e.g. that are stored in secure memory and that are not accessible by components and/or processes outside of the key generator 414. The key generator 414 generates the signature-time signing key to reside within a signing key space. The signing key space may indicate a predefined and finite set of values the signature-time signing key may take. In certain examples, the signature-time signing key may be sampled from the signing key space. In certain examples, the key generator 414 may generate the signature-time verification key as a function as a sampled signature-time signing key. The key generator 414 may generate the signature-time verification key using a lattice instantiation.

FIG. 4A also shows a linear sketch generator 412 to generate a linear sketch. The linear sketch is lattice-compatible, e.g. may be generated as a function of a signature-time signing key that resides in a signing key space for the lattice instantiation. The linear sketch is thus compatible with lattice-based digital signature schemes. The lattice instantiation may comprise an implementation of a Learning With Errors (LWE) scheme, such as the Ring-LWE variant. The signing key space used by the key generator 414 may be configured as a space defined by the lattice instantiation. In one case, the signing key space may comprise a ring space [symbol] _{q} of a Ring-LWE digital signature scheme. An example comparative Ring-LWE, that may be modified to implement the present examples, is described in Vadim Lyubashevsky's paper: “Lattice signatures without trapdoors”, as published in EUROCRYPT 2012, volume 7237 of LNCS, pages 738-755. Springer, Heidelberg, April 2012, the contents of which are incorporated by reference herein.

The linear sketch generated by the linear sketch generator 412 comprises a function of the fuzzy data 405. In one case, the linear sketch comprises a linear function of the fuzzy data 405 and the signature-time signing key. In one case, the linear sketch may be generated by a linear sketch function that computes an inverse hash of the signature-time signing key and then returns a linear sum of the inverse hash and a scaled version of the fuzzy data. In this case, the inverse hash may be an inverse of a hash function that is configured to generate an output that resides within the signing key space. The linear sketch may be seen as part of an encoding scheme, where the linear sketch represents an encoding of the signature-time signing key using the fuzzy data as an encoding key. The signature-time signing key is thus kept secret.

In the signing device 402 of FIG. 4A, a signature generator 416 is communicatively coupled to the message interface 408, the linear sketch generator 412 and the key generator 414. The signature generator 416 is arranged to receive the message 415 from the message interface 408 and the signature-time signing key from the key generator 414 and to supply output interface 418 with a digital signature 420 for output. The signature generator 416 is configured to generate the digital signature 420 using the message 415 and the signature-time signing key. The signature generator 416 is configured to generate a lattice digital signature sigma for inclusion in the digital signature 420. The lattice digital signature sigma is generated using the lattice instantiation. The lattice digital signature sigma may comprise multiple sub-components and may be generated according to a signing process for a lattice digital signature scheme, such as a Ring-LWE lattice instantiation. In the present example, the digital signature 420 comprises at least the linear sketch from the lattice-based linear sketch generator 412, the signature-time verification key from the key generator 414 and the lattice digital signature sigma that is generated by the signature generator 416. The digital signature 420 is verifiable using an initialisation-time verification key that varies from the signature-time verification key, wherein a variation of the signature-time verification key is comparable to a predefined homomorphic threshold. The process of verification is described in more detail with reference to the examples of a verification device presented below.

In one implementation of the signing device 402, the key generator 414 is configured to generate a signature-time signing key by sampling a signing key space. In examples, the signing key space may comprise an abelian group, which is compatible with the lattice instantiation used to generate the lattice digital signature sigma. The signature-time verification key is then generated by the key generator 414 as a function of the sampled signature-time signing key. In this implementation, the signature generator 416 is configured to use the sampled signature-time signing key to digitally sign the message 415 using a signing function. The signing function may comprise a signing function of the lattice instantiation that is configured to output the lattice digital signature sigma. Also, the linear sketch generator 412 is configured to use a linear sketch function that takes the sampled signature-time signing key and the fuzzy data 415 as input.

In certain cases, the key generator 414 and the signature generator 416 are configured to use a public parameter to configure the applied functions. The public parameter may be provided as an input to the signing device 402. The public parameter may comprise two components: a first component to configure the key generator 414 and the signature generator 416 and a second component to configure the linear sketch generator 412.

FIG. 4B shows an example 430 of a verification device 432. The verification device 432 may be used as part of the cryptographic systems shown in FIGS. 1 to 3, e.g. to implement the signature engine 135, 235, 335, The verification device 432 may be used to verify the digital signature 420 generated by the signing device 402. However, the signing device 402 and the verification device 432 may in certain cases be implemented by separate entities at separate locations, e.g. as shown in FIG. 2. They may also, in other cases, be combined into a single device, e.g. as shown in FIG. 3.

The verification device 432 of FIG. 4B comprises a digital signature interface 434, a message interface 436 and a key data interface 438. As before, these interfaces may be separate electrical interfaces to other electronic components, such as secure transceivers, and/or may comprise a general systems bus interface, e.g. a secured interface to a memory. The digital signature interface 434 is configured to receive the digital signature 420 as generated by the signing engine 402. Hence, the digital signature comprises a signature-time verification key for the signee, a lattice digital signature sigma and a linear sketch. The message interface 436 may be implemented in a similar manner to the message interface 408. The message interface receives the message 415. The message 415 may comprise a binary bit sequence that is identical to a binary bit sequence of the message 415 in FIG. 4A. In certain cases, it may not be known whether the binary bit sequence of the message 415 as input to the verification device 432 is the same as the binary bit sequence of the message 415 as input to the signing device 402. The verification device 432 may be used to check whether this is the case. As with other examples, the message 415 may simply comprise data to be verified, e.g. may comprise a file or data stream as well as an explicit bit sequence for a string message. The key data interface 438 is to receive key data 440 comprising at least an initialisation-time verification key for the signee. The initialisation-time verification key is a result of a key generation operation at a time that differs from the time of generation of the digital signature 420, e.g. a time preceding the time of signing. The initialisation-time verification key and the signature-time verification key are both generated using signing keys that reside in a signing key space defined by the lattice instantiation. For example, the initialisation-time verification key may be generated by a key generator that operates in a similar manner to the key generator 414 of FIG. 4A. The initialisation-time verification key may be generated during a user registration process prior to authentication using the verification engine. In one case, fuzzy data associated with the user is also obtained at initialisation-time, and this is used to generate a linear sketch that forms part of the key data 440. For example, the linear sketch generator 412 and the key generator 414 may be applied at initialisation time to generate an initialisation-time verification key and an initialisation-time linear sketch.

The verification device 432 of FIG. 4B comprises a verification engine communicatively coupled to the digital signature interface 434, the message interface 436, and the key data interface 438 to respectively receive the digital signature 420, the message 415 and the key data 440, The verification engine 442 is configured to perform a series of operations to verify the digital signature 420. A first operation involves generating a reconstructed verification key using the linear sketch from the digital signature 420 and the initialisation-time verification key from the key data 440. In certain cases, the reconstructed verification key may be generated by first determining a linear sketch difference between the linear sketch from the digital signature 420 and a linear sketch from the key data 420. A key reconstruction function may then take the linear sketch difference and the initialisation-time verification key as input and generate the reconstructed verification key. The linear sketch difference may be generated by a difference reconstruction (DiffRec) function as used within a linear-sketch-based signature scheme. The key reconstruction function may be based on the M_{VK} function as used within the linear-sketch-based signature scheme, this function being similar to the linear sketch function used by the linear sketch generator 412. A second operation involves computing a distance metric that indicates a measure of difference for the signature-time verification key obtained from the digital signature 420. This distance metric may be a measure of difference between the signature-time verification key and the reconstructed verification key. Due to the use of fuzzy data 405, the signature-time verification key may not equal the initialisation-time verification key that is available to the verification engine 442 by way of the key data 440, The distance metric allows the verification engine 442 to determine a measure of “closeness” that may be used to determine if the signature-time verification key is “close enough” to the initialisation-time verification key to allow for verification. The distance metric may be a function of the initialisation-time verification key. In one case, the distance metric may be compared to a threshold β that indicates a level of weak homomorphism (e.g. the digital signature scheme is β-weakly homomorphic). The threshold β may be non-zero. Having computed the distance metric, the verification engine 442 is configured to use at least the distance metric to verify the digital signature 420 and to output, via an output interface 444, an indication of verification success or failure 446. Verification success may be used to, among other uses, authenticate a user that signed the message 415, confirm the message 415 as being approved by the user, and/or indicate that the data of the signed message 415 matches the data of the received message 415.

In one case, the distance metric may result from a comparison of the signature-time verification key, as received as part of the digital signature 420, and the initialisation-time verification key, as received as part of the key data 440. If the distance metric is greater than a threshold, the verification engine 442 may indicate a verification failure. In one case, a check may also be made to confirm that the lattice digital signature sigma is verified. This may be performed using a verification function from a lattice digital signature scheme, as applied to the digital signature 420 (e.g. the lattice digital signature sigma and verification key components) and the message 415. In this case, the digital signature is verified based on at least the computed distance metric and an output of the sigma verification.

FIG. 4C shows a computing device 450 that implements a cryptographic system. The computing device 450 comprises at least one processor 452, a memory 454, a sensor interface 456, a network interface 458 and an output interface 460. These components are electrically coupled using a systems bus 462. A storage medium 470 is also electrically coupled to the storage bus 462. The sensor interface 456 may implement the fuzzy data interface 404 of FIG. 4A. The sensor interface 456 may comprise a secure interface to store sensor data read from a biometric sensor in a secure area of memory 454. The network interface 458 may couple the computing device 450 to a communications channel such as communication channel 206, e.g. as implemented over networks 208 and 308.

The computing device 450 also comprises electronic circuitry to implement a number of cryptographic functions. This electronic circuitry may comprise one or more microprocessors or modular processing systems. In certain examples, the electronic circuitry may comprise dedicated processing chips that are securely installed on a motherboard of the computing device 450, e.g. in the form of SoCs, ASICs or FPGAs. The electronic circuitry includes a key generator 472, signature circuitry 474 and verification circuitry 476. The signature circuitry 474 may implement the signing device 402 of FIG. 4A, or one of the signature engines 110, 210, 310 from FIGS. 1 to 3. The verification circuitry 476 may implement the verification device 432 of FIG. 4B, or one of the verification engines 135, 235, 335 from FIGS. 1 to 3. In one case, the output interface 460 may comprise a display to display the verification indication 446. In another case, the verification indication 446 may be used to communicate with a client device using the network interface 458.

FIG. 4D shows a computing device 455 that is a variation of the computing device 405 of FIG. 4C. In FIG. 4D, the storage medium comprises computer program code instructions) to implement the number of cryptographic functions that are implemented using electronic circuitry in FIG. 4C. The storage medium may be non-transitory, e.g. a magnetic or solid-state disk drive or the like. As such, the computer program code comprises key generator code 482, signature engine code 484 and verification code 486. The signature engine code 484 may implement the signing device 402 of FIG. 4A, or one of the signature engines 110, 210, 310 from FIGS. 1 to 3. The verification engine code 486 may implement the verification device 432 of FIG. 4B, or one of the verification engines 135, 235, 335 from FIGS. 1 to 3. The computer program code may be loaded into the memory 454 for execution by the at least one processor 452. The computer program code may form part of an operating system of the computing device 455, e.g. may be securely executed as part of a kernel or operating system service in protected memory.

The key generator circuitry 472 and the key generator code 484 implement a key generator. The key generator may be similar to the key generator 414 shown in FIG. 4A. The key generator implemented by the key generator circuitry 472 and the key generator code 484 may be used by the signature circuitry 474 or the signature engine code 484, e.g. via an application programming interface call to implement the functionality of the key generator 414 described herein. The key generator implemented by the key generator circuitry 472 and the key generator code 484 may also be used to generate at least an initialisation-time verification key as described above. The key generator is in general configured to generate key data such as the key data 140, 240, 340, 440 of FIGS. 1 to 4. Examples of how the key generator may generate the initialisation-time verification key are described in more detail below.

In one example, the key generator is configured to generate an initialisation-time signing key and an initialisation-time verification key, e.g. at an initialisation or registration phase before any digital signature is created. The initialisation-time signing key may be sampled from the defined signing key space. The initialisation-time signing key may not be used outside of the key generator. The initialisation-time verification key may then be generated as a function of the initialisation-time signing key. The function may generate the initialisation-time verification key as a bound in a lattice instantiation, e.g. based on vk=ask+e as described in more detail below. The initialisation-time signing key may, in certain cases, be used to generate a linear sketch that is also output by the key generator, e.g. in a similar manner to the generation of a linear sketch at signature time as described above. In this case, the initialisation-time linear sketch may comprise a function of the initialisation-time signing key and a measurement of fuzzy data, such as an initial biometric scan that differs from a biometric scan performed as signature time. As such the fuzzy data used to generate a linear sketch at initialisation time may vary from the fuzzy data used to generate the linear sketch that forms part of a digital signature at signature time. If a linear sketch is generated by the key generator it may form part of the key data 140, 240, 340, 440 of FIGS. 1 to 4, together with the initialisation-time signing key.

The previously-described examples operate on fuzzy data. Fuzzy data may comprise data whose value varies over a data distribution. This data distribution may be multivariate. The fuzzy data may comprise a fixed-length binary data sequence. The fuzzy data may represent one or more real numbers. The data distribution may be defined with reference to this fixed-length binary data sequence. In certain cases, biometric data, such as a fingerprint or iris scan, may be converted into an i-bit integer. A metric space X for the fuzzy data may be defined as X:=[0,1)^{\hat{n}}⊂ [symbol] ^{\hat{n}}, where \hat{n} is a parameter that is dependent on the implementation (e.g. the nature of the fuzzy data such as a dimension of acquired biometric data). The parameter \hat{n} may be parameterized by a security parameter κ. The metric space may be defined with a distance function, e.g. where a distance between any two instances of the fuzzy data has set properties. For example, the metric space may be defined as an abelian group with respect to coordinate-wise addition modulo 1. The data distribution may be selected as an efficiently sampleable distribution over a discretized version of the metric space. Here, discretization for the distribution may be performed by rounding to a length λ. In one case, fuzzy data may comprise data that reflects a known pattern with noise, such as an image or other measurement of a defined object.

In one case, a verification key (e.g. either at initialisation time or signature time) may be generated according to a Ring-LWE variant. In this case, each verification key, vk, from the group of the initialisation-time verification key and the signature-time verification key is a function of a signing key, sk, a configuration parameter, a, and a noise term, e, that is sampled from a defined noise distribution. The signing key may be represented as one polynomial, whereas the parameter, a, and noise term, e, may be represented as a vector of polynomials, as per Ring-LWE schemes. In a specific Ring-LWE example, vk=ask+e. The signing key may be a sample from the signing key space. The configuration parameter is selected based on the signing key space, e.g. if a signing key space is [symbol] _{q} then the configuration parameter may be sampled (i.e. selected) from [symbol] _{q}^{k}. The configuration parameter may comprise at least a component of the aforementioned public parameter. The configuration parameter may be generated by a setup procedure. The setup procedure may take the security parameter K as an input and output the configuration parameter. The configuration parameter may be provided as an additional (public) input to key generation, signing and verification operations.

The signing key space [symbol] _{q} may be seen as a vector space [symbol] _{q}ⁿ, and in a Ring-LWE example may be defined as a ring space [symbol] _{q}[X]/(Xⁿ+1), where X is the aforementioned metric space of the fuzzy data. The signing key space may be an abelian or commutative group. In a linear sketch function, a linear sketch may be computed as R+T·X, where X is the fuzzy data, i.e. X⊂[0,1)^{\hat{n}}, which may be rearranged into ([0,1)^{l})ⁿ where n is a lattice dimension that may be defined as a polynomial of the security parameter κ, l is a bit-length for the fuzzy data (e.g. a scalar) and \hat{n} is a multiple of n. In this case, R may represent a processed signing key component, e.g. an inverse hash function of a sampled signing key component. If the hash function is configured to output values within the signing key space, then R∈( [symbol] _{q}^{l})ⁿ∈( [symbol] _{q}^{l})ⁿ and T·X∈([0,T)^{l})ⁿ⊂( [symbol] _{q}^{l})ⁿ. Addition and negation operations associated with the linear sketch may be performed over ( [symbol] _{q}^{l})ⁿ coordinate-wise. In one case, T is a configurable parameter of the cryptographic system, indicating a number of parallel repetitions where computing components of the lattice digital signature sigma. The lattice digital signature sigma may also comprise components relating to a further noise sample.

In one case, using a Ring-LWE variant, the lattice digital signature sigma may comprise a digest component, e.g. as per lattice digital signature schemes. This may be generated using a digital signature hash function. This function may comprise a function of a temporary (or “sigma”) verification key b generated by the lattice instantiation (e.g. a signing function of the instantiation that generates the lattice digital signature sigma) at signature-time, the message (i.e. one of 115, 215, 315 etc.) and additional sampled components from the signing key space. In one case, the lattice digital signature sigma may comprise (“sigma”) components zₛⁱ and zₑⁱ that are generated using T sampled (“sigma”) signing key components yₛⁱ, where yₛⁱ← [symbol] _{q} (e.g. the components being samples, i.e. random selections, from the signing key space as described above) and T sampled noise components yₑⁱ. The T outputs may be supplied to the digital signature hash function, together with the message and the temporary verification key b to generate the digest. Sampling here may be taken as a random selection from the signing key space (which may in implementations be pseudo-random based on the limitations of random number generators). In one case, the inputs to the hash function may be concatenated, and the hash function applied to the resultant bit sequence. The digest, the T components zₛⁱ and zₑⁱ, and the temporary verification key b may be output by the lattice instantiation as the lattice digital signature sigma.

In a case that uses a Ring-LWE variant, the key generator may be configured to sample an initialisation-time signing key, sk_{I}, from the signing key space and a noise term from the defined noise distribution, and compute the initialisation-time verification key using the verification key computation, vk_{I}=ask_{I}+e. The configuration parameter may comprise the same configuration parameter that is used for the signature-time verification key computations.

In one case, the distance metric comprises the l-∞ metric that is evaluated between the signature-time verification key and the reconstructed verification key. In one case, the l-∞ metric is also used to compare the initialisation-time verification key with the temporary verification key b that forms part of the lattice digital signature sigma, Verification of the lattice digital signature sigma may be made using a lattice digital signature scheme verification function that takes the signature-time verification key, the message and the digital signature sigma as input.

If a digest is generated as per the Ring-LWE variant described above, verification of the lattice digital signature sigma by a verification engine as described herein may comprise computing a second version of the digest using the lattice digital signature sigma. In one case, the same digital signature hash function as was applied by a lattice digital signature signing function may be applied to the message, the temporary verification key b as extracted from the lattice digital signature sigma and the T components zₛⁱ and zₑⁱ. If the second version of the digest does not match the digest obtained from the lattice digital signature sigma, then a verification failure of the lattice digital signature sigma may be indicated.

In certain cases, a size of a digest forming part of the lattice digital signature sigma may be reduced by omitting certain bits of the digest input, e.g. by only including significant bits of a result of applying the verification key computation to sampled signing key components.

In certain cases, the cryptographic system is configured using one or more parameters. These parameters may comprise: a lattice dimension for the lattice instantiation (e.g. n as used above—this may be set as a polynomial of a security parameter κ); a size of a public configuration parameter (e.g. k for the configuration parameter space described above); a predefined homomorphic threshold (e.g. β as described above); a modulus size (e.g. q) used to define the signing key space (e.g. [symbol] _{q}); a measure of variation for the defined noise distribution; and a number of values to compute for the linear sketch (e.g. T as above). The modulus size may be constrained to be a prime number. Values for these parameters may be selected depending on security and implementation requirements. A noise or error distribution may be defined as a discrete Gaussian distribution. Variables as described herein may be represented as arrays, vectors or tensors of a defined size. As an example, a cryptographic system that provides 128-bit security may be configured using the following parameters values: n=4096, k=3, q=2⁵²+4·2³+5, T=20, a variance set based on a Gaussian width size of 2^{7.6}. The dimension 11 of the fuzzy data metric space in this example was 10*n. The cryptographic system of this example was configured to generate 2¹⁵ signatures (where Q=2¹⁵), e.g. a user could sign using biometric data three times a day for 30 years. The table below summarises certain parameters used in an example cryptographic system including example properties and values for a test implementation:

| Parameters | Description | Example Properties | Example Value |
|---|---|---|---|
| n | lattice dimension | poly(κ) | 4096 |
| k | length of vector ϵ [symbol] _{q}^{k} | n/a | 3 |
| q | modulus size | O((n(Q)^{1.2}) | 2⁵² + 4 · 2³ + 5 |
| σ (or αq) | width of Gaussian | O((n(Q)^{0.7}) | 2^{7.6} |
| β | threshold | O(Q^{0.7}) | ≥0 |
| T | parallel repetitions | n/a | 20 |

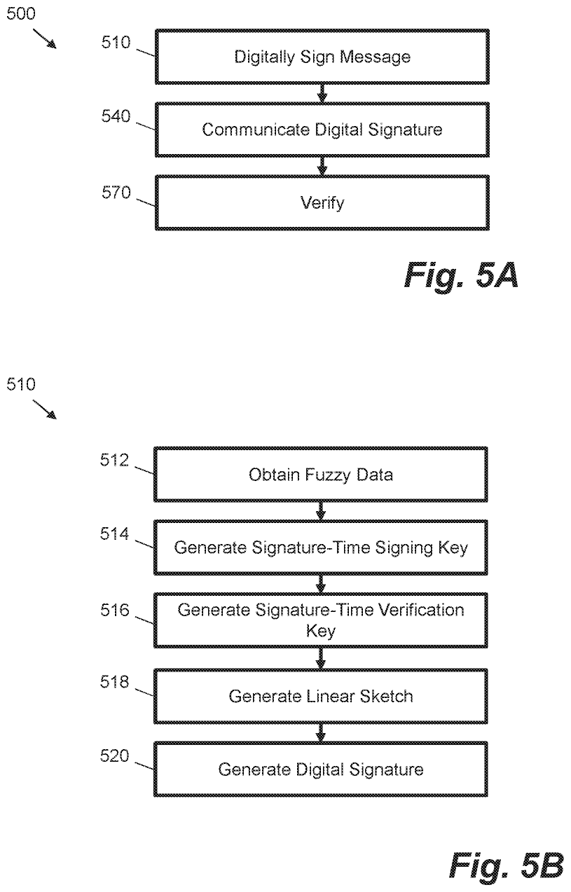

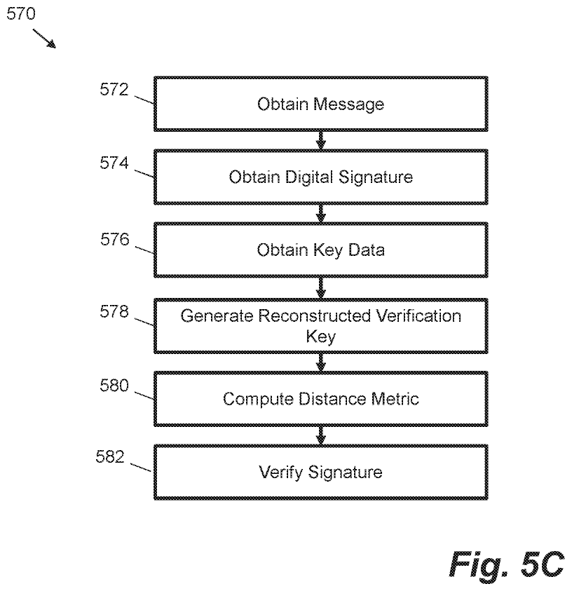

FIG. 5A shows a cryptographic method 500 according to an example. This method 500 may be used to authenticate a user. At block 510, the method comprises digitally signing a message at a first device. The first device may comprise, among other examples, the first terminal 202 of FIG. 2, one of the terminals 300 in FIG. 3, or the signing device 402 of FIG. 4A. Block 510 results in a digital signature such as the digital signature 120, 220, 320, 420 in the previously-described Figures. At block 520, the digital signature is communicated from the first device to a second device. The second device may comprise, among other examples, the second terminal 204 of FIG. 2, one of the terminals 300 in FIG. 3, or the verification device 432 of FIG. 4B. The communication may take place over a communication channel, e.g. a wired and/or wireless connection and/or a communications channel setup over one or more networks. At block 530, the message is verified at the second device, i.e. it is determined whether the message has been validly signed by the signee.

FIG. 5B shows an implementation of block 510 that may take place at the first device. The method of FIG. 5B may be performed by a signing device or signature engine as previously described. At block 512, a message is obtained that is to be digitally signed by a signee. This may comprise the message 115, 215, 315, 415 of the previously-discussed Figures. At block 514, fuzzy data associated with a signee is obtained. This may comprise the fuzzy data 105, 205, 305, 405 of the previously-described Figures. At block 514, a signature-time signing key is generated. The signature-time signing key is generated to reside within a defined signing key space, e.g. [symbol] _{q}. The signature-time signing key is sampled from the defined signing key space. At block 516, a signature-time verification key is generated. The signature-time verification key as a function of the signature-time signing key. In one case, the signature-time verification key is generated using a Ring-LWE formulation, e.g. using vk=ask+e as described above. In another case, another lattice-based function may be used.

Once the pair of signature-time keys have been generated via blocks 514 and 516, at block 518, a lattice-compatible linear sketch is generated. In this case, a lattice-compatible linear sketch means that a set of functions that implement a linear sketch are adapted to be compatible with a set of lattice-based functions that are used to generate signing and verification keys, and that are used to generate a lattice digital signature sigma (e.g. that are used to sign the message in accordance with a lattice digital signature scheme), The compatibility may be achieved by configuring the output spaces of the set of functions to be complementary and/or compatible. The linear sketch comprises a function of the fuzzy data and the signature-time signing key. It may comprise a linear function of the fuzzy data and a sample from the signing key space. The linear sketch comprises a function of a sampled key from block 514 and the fuzzy data from block 512. The signing key space is a space defined by the lattice instantiation. The linear sketch may be configured to operate in this space (e.g. by calibrating a hash function used with the linear sketch to output values within this space). Within the linear sketch, the fuzzy data is used as an encoding key to encode the signature-time signing key.

At block 520, a digital signature for the message is generated. The digital signature comprises the linear sketch, the signature-time verification key and a lattice digital signature sigma. The lattice digital signature sigma may be generated as part of block 520 based on the message and the signature-time signing key. For example, the lattice digital signature sigma may comprise a digest that is generated using the message, a temporary verification key b and components zₛⁱ and zₑⁱ computed based on the lattice instantiation. The digital signature may then be output. The digital signature is verifiable using an initialisation-time verification key that varies from the signature-time verification key. For example, a variation of the signature-time verification key is comparable to a predefined homomorphic threshold, and if the variation is greater than the threshold then an indication of verification failure may be generated.

FIG. 5C shows a cryptographic method for performing block 570 of FIG. 5A. The method of FIG. 5C may be performed by a verification device or verification engine as previously described. At block 572, a message is obtained. This may comprise the message 115, 215, 315, 415 of the preceding Figures. The message may be obtained from data transmitted over a communications channel. The blocks of the method are selected to verify the message as being digitally signed by a signee, e.g. the signee as described with reference to FIGS. 5A and 5B. Alternatively, the blocks may be seen as verifying the integrity of the message. At block 574, a digital signature is obtained. This may be obtained as a result of the method shown in FIG. 5B as performed on another device. The digital signature thus comprises a lattice digital signature sigma, a signature-time verification key for the signee and a linear sketch. The linear sketch may comprise a linear function of the signature-time signing key and the fuzzy data. In one case, the lattice digital signature sigma may further comprise digital signature data such as digest, a temporary verification key b and components zₛⁱ and zₑⁱ. The lattice digital signature sigma is generated using the signature-time signing key according to a lattice instantiation. The linear sketch is generated based on fuzzy data associated with the signee, wherein the linear sketch is compatible with the lattice instantiation.

At block 576, key data is obtained. The key data comprises at least an initialisation-time verification key for the signee. In a case where an initial key generation operation also generates an initialisation time linear sketch, this may also be provided as part of the key data. The key data may be public. The initialisation-time verification key and the signature-time verification key are both generated using signing keys that reside in a signing key space defined by the lattice instantiation.

At block 578, a reconstructed verification key is generated from the linear sketch and the key data. The reconstructed verification key may be generated by determining a difference between a linear sketch forming part of the key data and a linear sketch forming part of the digital signature. The difference may be used, together with the initialisation-time verification key from the key data to construct a version of the verification key (the “reconstructed” key) that is closer to the signature-time verification key.

At block 580, a distance metric is computed indicating a measure of difference for the signature-time verification key. The distance metric may indicate a measure of difference between the signature-time verification key and the reconstructed verification key. Via the reconstructed verification key, the distance metric may be seen as a function of the initialisation-time verification key. In one case, the distance metric may comprise the metric (also alternatively referred to as the Chebyshev or “chessboard” distance). The distance metric may be evaluated with respect to a difference between the signature-time verification key and the reconstructed verification key.

At block 582, the computed distance metric is used to verify the digital signature. In one case, the distance metric is compared to a threshold, β, and if it is above the threshold, verification is deemed a failure, e.g. the user cannot be authenticated, and it is not confirmed that message was signed by the user. In one case, verifying the digital signature further comprises verifying the lattice digital signature sigma using the signature-time verification key and the message, the verifying being performed according to the lattice instantiation, e.g. as per a verification function for a lattice digital signature scheme. In this case, verifying the digital signature based on at least the computed distance metric comprises verifying the digital signature based on the computed distance metric and a result of verifying the lattice digital signature sigma. For example, if both checks pass then the digital signature is verified.

In certain examples, any one of the methods shown in FIGS. 5A to 5C may comprise, as an initial operation, generating the key data for the signee. In one case, this may comprise generating an initialisation-time signing key, the initialisation-time signing key residing within the signing key space and generating the initialisation-time verification key as a function of the initialisation-time signing key and a noise term that is sampled from a defined noise distribution. For example, the initialisation-time signing key may be a sample from the signing key space and the initialisation-time verification key may be computed using the Ring-LWE verification key computation described above. Only the initialisation-time verification key may be returned from the key generation operation. The key generation operation may take place when a user registers with a particular security system. The key generation operation may also generate an initialisation-time linear sketch that also forms part of the key data. The key data may be stored in a data store that is indexed by an identifier for the user, e.g. such that this key data may be retrieved as part of block 576. In one case, generating the key data also comprises generating a linear sketch as a function of fuzzy data (e.g. an initial biometric scan) and the initialisation-time signing key.

In certain cases, each verification key from the group of the initialisation-time verification key and the signature-time verification key is a function of a signing key, a configuration parameter and a noise term that is sampled from a defined noise distribution, the configuration parameter being selected based on the signing key space. For example, this may be the case where the verification key computation is based on a Ring-LWE variant. In certain cases, the lattice instantiation is defined based on a predefined lattice dimension and the signing key space is defined based on a predefined modulus size. The lattice dimension and the modulus size may be configured to meet a required level of security for any cryptographic system or method.

In certain cases, the linear sketch is defined based on an inverse of a hash function, the hash function outputting values that are within the signing key space.

In certain cases, the initialisation-time verification key and the signature-time verification key are public keys and the signature-time signing key is a private key, e.g. suitable for use in a public key infrastructure (PKI).

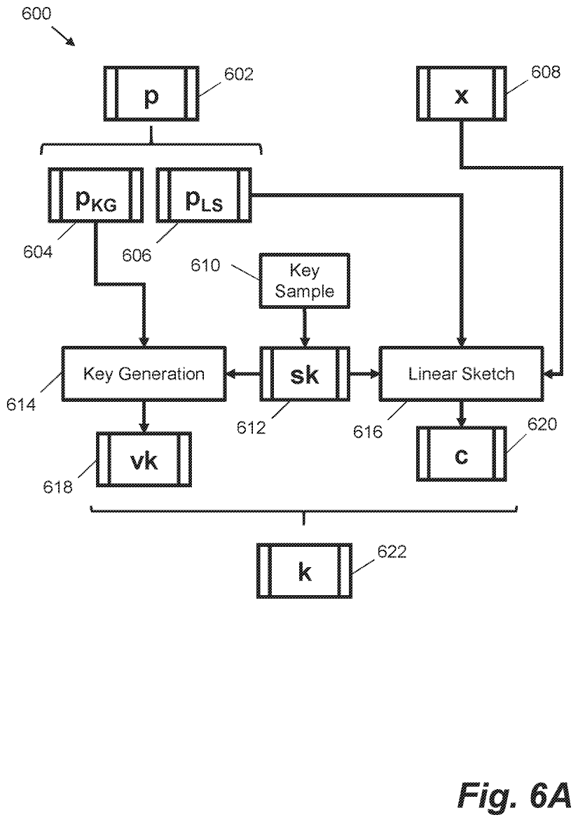

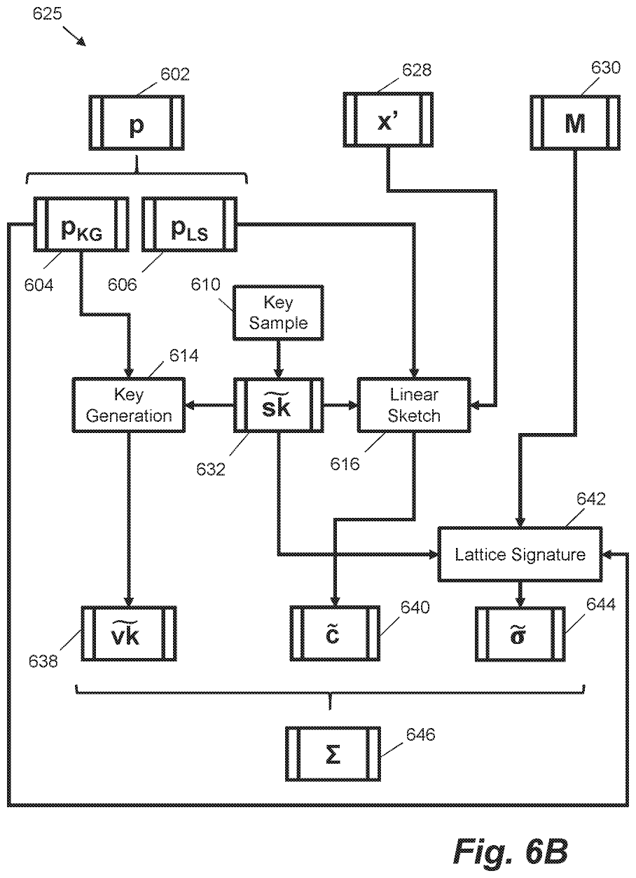

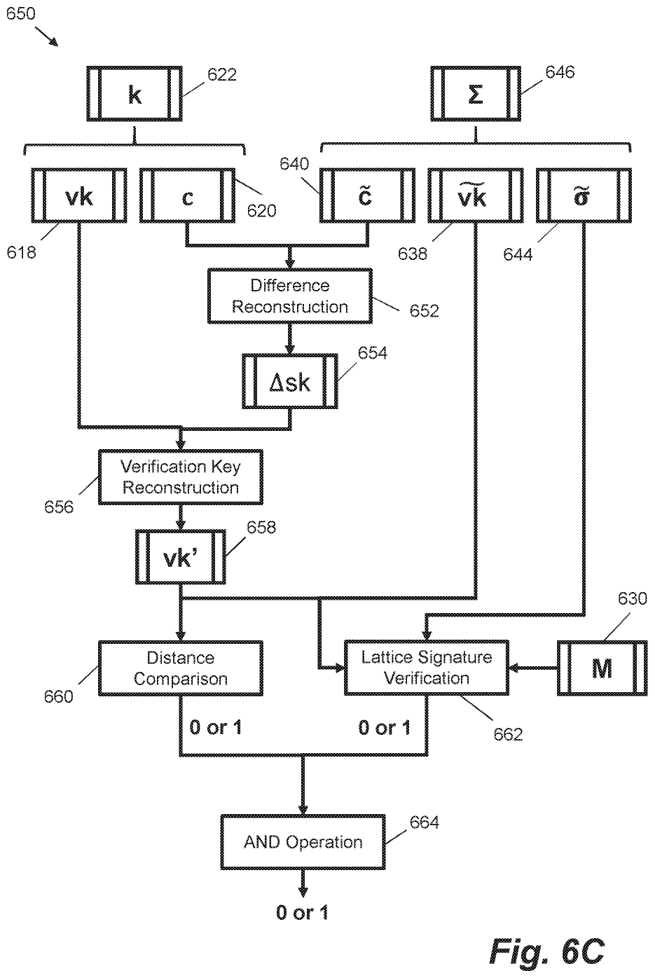

FIGS. 6A, 6B and 6C show examples of a key generation function, a signature function and a verification function. These functions may be used and/or implemented by the aforementioned systems and methods.

The key generation function 600 of FIG. 6A receives a public parameter 602 as input. The public parameter comprises two components: a first key generation (“KG”) parameter 604 and a second linear sketch (“LS”) parameter 606. The key generation parameter 604 may be generated by a setup function of a lattice digital signature scheme. The linear sketch parameter 606 may be generated by a setup function of a linear sketch scheme. The setup function of the lattice digital signature scheme may comprise obtaining a sample from [symbol] _{q}^{k} and the setup function of the linear sketch scheme may comprise obtaining a sample from ( [symbol] _{q}^{l})ⁿ. The key generation function 600 of FIG. 6A also receives fuzzy data 608 as input.

The key generation function 600 of FIG. 6A comprises three functional sub-components: a key sample sub-component 610, a key generation sub-component 614 and a linear sketch sub-component 616. The key sample sub-component 610 is configured to generate a signing key 612 by sampling from a signing key space. The key generation sub-component 614 is configured to generate a verification key 618 using the key generation parameter 604 and the signing key 612. The key generation sub-component 614 may be implemented using a sub-component from a lattice digital signature scheme and may generate the verification key according to a Ring-LWE instantiation, e.g. as vk=ask+e, where the key generation parameter 604 is set as a. The linear sketch sub-component 616 is configured to generate a linear sketch 620 using the linear sketch parameter 606, the signing key 612 and the fuzzy data 608. The linear sketch sub-component 616 may be implemented using a sub-component from a linear sketch scheme and may compute the linear sketch as H_{z}⁻¹(sk)+T·X, where H_{z} is a hash function compatible with the lattice instantiation (i.e. where the range of the hash function corresponds to the signing key space), sk is the signing key 612, T is a configurable scaling parameter and X is the fuzzy data 608. The key generation function 600 outputs the verification key 618 and the linear sketch 620 as key data 622. The key generation function 600 may be implemented by a key generator 472 as shown in FIG. 4C or key generator code 482 processed by a processor 452 as shown in FIG. 41).

The key generation function 600 of FIG. 6A may be adapted to generate key data 622 at initialisation time. It may also be used as part of a signature function 625 as is shown in FIG. 6B. For example, the three functional sub-components 610, 614 and 616 may comprise dedicated circuitry and/or computer program code that is processed by a processor of a computing device.

The signature function 625 of FIG. 6B may represent a process performed by the signature engines 110, 210 and 310 of FIGS. 1 to 3, the signing device 402 of FIG. 4A, the signature circuitry 474 of FIG. 4C and/or the signature engine code 484 when implemented by processor 452 of FIG. 4D. The signature function 625 operates upon input data in the form of a public parameter 602, fuzzy data 628 and a message 630. For at least a given user, the public parameter 602 is the same parameter as is used by the key generation function 600 of FIG. 6A, and again comprises a key generation parameter 604 and a linear sketch parameter 606. The key sample sub-component 610, the key generation sub-component 614 and the linear sketch sub-component 616 operate as described with reference to FIG. 6A, only in this case a new signature-time signing key 632 is sampled and a new measurement of fuzzy data 628 is supplied. The key generation sub-component 614 generates a signature-time verification key 638 and the linear sketch sub-component 616 generates a signature-time linear sketch 640. As a new sample is performed by the key sample sub-component 610 and a new measurement of fuzzy data 628 is used to generate the signature-time linear sketch 640, the signature-time verification key 638 and the signature-time linear sketch 640 differ from their initialisation-time counterparts, e.g. an initialisation-time verification key 618 and an initialisation-time linear sketch 620 that forms part of key data 622.

The signature function 625 also comprises a lattice signature sub-component 642 that is configured to generate a lattice digital signature sigma 644 based on the key generation parameter 604, the message 630 and the signature-time signing key 632. The lattice signature sub-component 642 may be implemented using a sub-component of a lattice digital signature scheme. The lattice signature sub-component 642 may generate a further temporary verification key b using the key generation parameter 604 and the signature-time signing key 632, e.g. in a similar manner to the key generation function 614, and this may form part of the lattice digital signature sigma, together with a digest and components generated from further signing key samples. The signature function 625 outputs digital signature 646 that comprises the signature-time verification key 638, the signature-time linear sketch 640 and the lattice digital signature sigma 644.

FIG. 6C shows an example verification function 650 that may be performed by the verification engines 135, 235 and 335 of FIGS. 1 to 3, the verification device 432 of FIG. 4B, the verification circuitry 476 of FIG. 4C and/or the verification engine code 486 when implemented by processor 452 of FIG. 4D. The verification function 650 operates on key data 622 and digital signature 646. The key data 622 may result from an initialisation time operation performed using the key generation function 600 of FIG. 6A. The digital signature 646 may result from the signature function 625 shown in FIG. 6B. In FIG. 6C, the initialisation-time verification key 618 and the initialisation-time linear sketch 620 are extracted from the key data 622, Similarly, the signature-time verification key 638, the signature-time linear sketch 640 and the lattice digital signature sigma 644 are extracted from the digital signature 646. The initialisation-time linear sketch 620 and the signature-time linear sketch 640 are input into a difference reconstruction sub-component 652, which compares the linear sketches to produce a difference measure 654. In this example, the difference measure represents a variation in the secret signing key, e.g. a variation between the initialisation time and the signature time. The difference reconstruction sub-component 652 may be implemented using a sub-component of a linear sketch scheme. It may act to determine a difference between the linear sketches, e.g. by subtraction, and apply the hash function H_{z} to the difference to produce the difference measure 654. In certain examples, the difference reconstruction sub-component 652 may also receive the linear sketch parameter 606 as an input.

Once the difference measure 654 is generated, it is input into a verification key reconstruction sub-component 656, together with the initialisation-time verification key 618, The verification key reconstruction sub-component 656 acts to reconstruct a verification key using the difference measure that may then be compared to the signature-time verification key 638. The verification key reconstruction sub-component 656 may also receive the key generation parameter 604 as an input. The verification key reconstruction sub-component 656 may reconstruct a verification key by applying the verification key computation to the difference measure 654, e.g. vk′=vk+pp_{KG}·Δsk. The verification key reconstruction sub-component 656 outputs a reconstructed verification key 658.

The verification function 650 of FIG. 6C evaluates two verification checks: a distance comparison 660 and a lattice signature verification 662. The distance comparison compares the reconstructed verification key 658 to the signature-time verification key 638. If the difference between the two verification keys is greater than a threshold (e.g. β), a verification failure (e.g. 0) is output. If the difference is less than or equal to the threshold, a verification success (e.g. 1) is output. The lattice signature verification 662 takes the lattice digital signature sigma 644, the message 630 and the signature-time verification key 638 as input and applies a verification. This verification may also comprise checking whether a difference between a temporary verification key b contained within the lattice digital signature sigma and signature-time verification key 638 is less than or equal to the threshold (e.g. β). A check may also be made that noise components zₑ are within a defined variance bound, and that a digest in the lattice digital signature sigma matches a digest reconstructed using components (e.g. zₛ and zₑ) and the temporary verification key b contained within the lattice digital signature sigma, and the message.

In FIG. 6C, in order for the verification function 650 to indicate a verification success, both the distance comparison 660 and the lattice signature verification 662 must be successful. This may be achieved by coupling the output of the distance comparison 660 and the lattice signature verification 662 to an AND gate 664, wherein a verification success (e.g. 1) is only output if both the distance comparison 660 and the lattice signature verification 662 are successful (e.g. output 1).

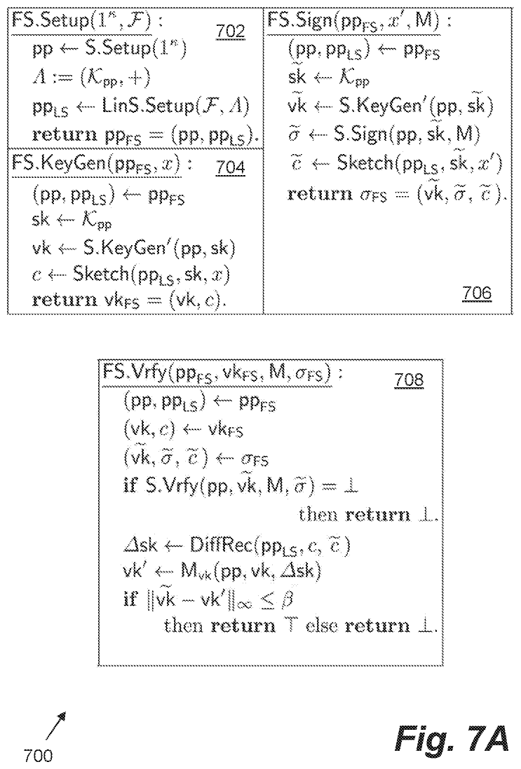

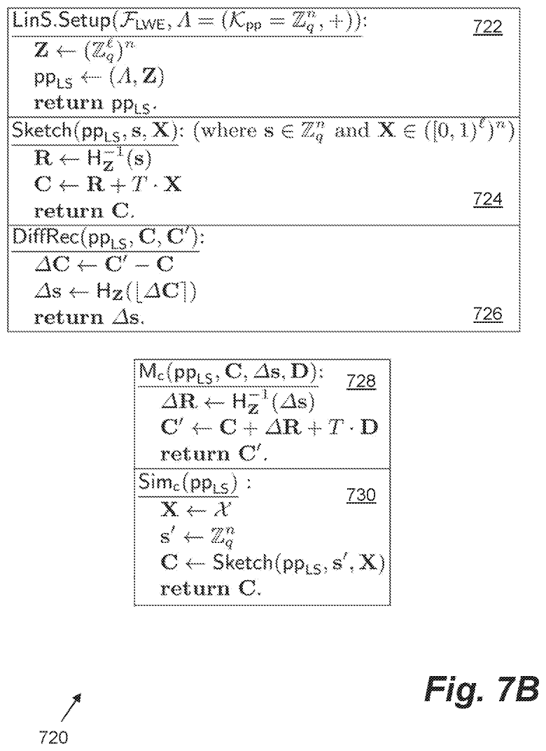

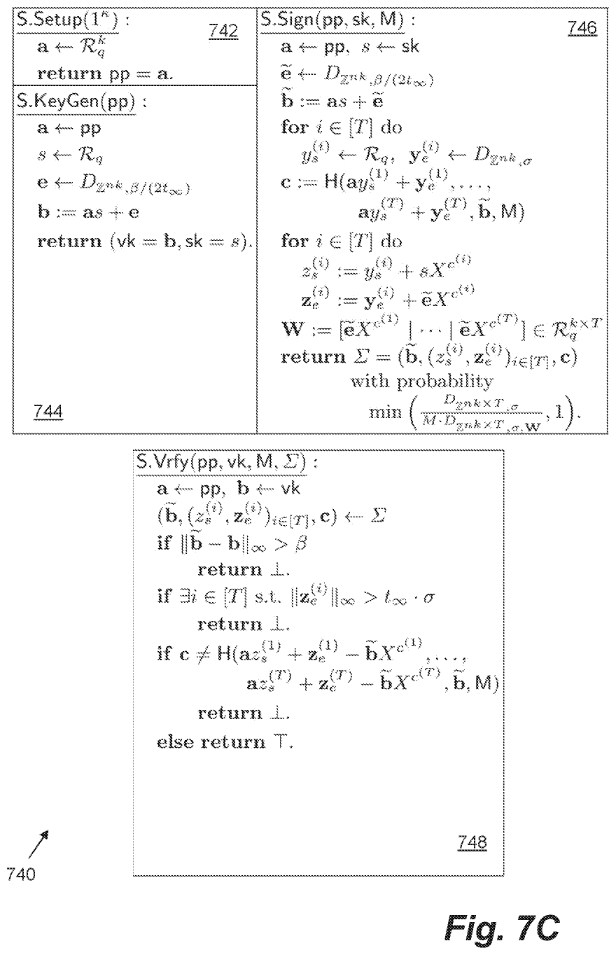

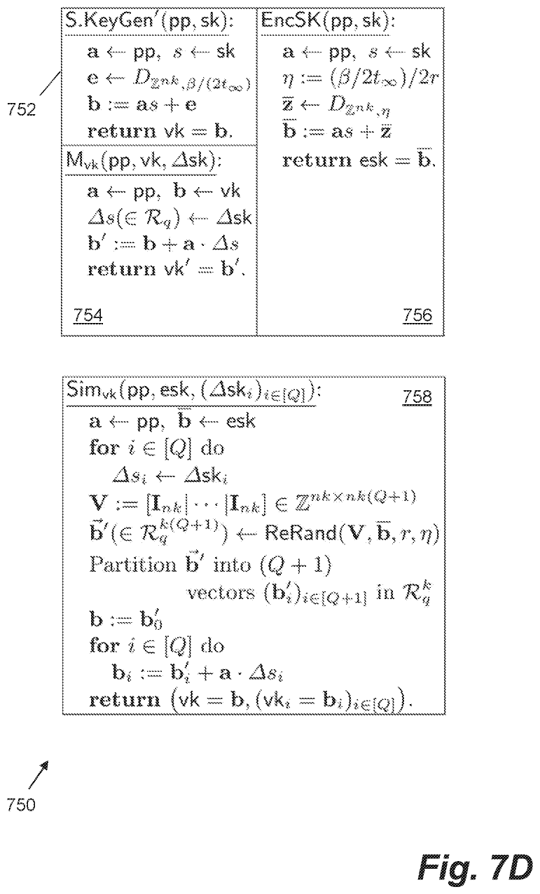

FIGS. 7A to 7D show example cryptographic functions that may be used to implement one or more of the examples described herein. FIG. 7A shows a number of example cryptographic functions 700 that may be used to implement a generic fuzzy signature scheme (“FS”), FIG. 7B shows a number of example cryptographic functions 720 that may be used to implement certain linear sketch functions within the generic fuzzy signature scheme, FIG. 7C shows a number of example cryptographic functions 740 that may be used to implement certain lattice digital signature scheme functions (“S”) within the generic fuzzy signature scheme and FIG. 7D shows a number of further cryptographic functions 750 for use with the generic fuzzy signature scheme.

The example cryptographic functions 700 of FIG. 7A comprise a setup procedure 702, a key generating procedure 704, a signature procedure 706 and a verification procedure 708. The setup procedure 702 receives a set of configuration parameters and outputs public configuration parameters for the generic fuzzy signature scheme. The key generating procedure 704 receives a public configuration parameter and fuzzy data, and outputs key data comprising a verification key and a linear sketch. The signature procedure 706 receives a public configuration parameter, fuzzy data and a message, and outputs signature data. The verification procedure 708 receives a public configuration parameter, key data, a message and signature data, and returns a verification indication (e.g. verified or not).

The example cryptographic functions 720 of FIG. 7B comprise a linear sketch setup procedure 722, a linear sketch procedure 724, a difference reconstruction procedure 726, a verification linear sketch procedure 728 and a simulator procedure 730. The example cryptographic functions 720 of FIG. 7B may be used to implement indicated sub-functions that form part of the example cryptographic functions 700 of FIG. 7A. The linear sketch setup procedure 722 receives a set of configuration parameters and outputs a public configuration parameter for the linear sketch. The linear sketch procedure 724 receives a public configuration parameter, a signing key and fuzzy data, and outputs a linear sketch. The difference reconstruction procedure 726 receives a public configuration parameter and two versions of a linear sketch, and outputs a difference metric. The verification linear sketch procedure 728 receives a public configuration parameter, a linear sketch, a difference metric and data and outputs a linear sketch. The simulator procedure 730 receives a public configuration parameter and outputs a linear sketch.

The example cryptographic functions 740 of FIG. 7C comprise a lattice setup procedure 742, a lattice key generating procedure 744, a lattice signature procedure 746 and a lattice verification procedure 748. The example cryptographic functions 740 of FIG. 7C may be used to implement indicated sub-functions that form part of the example cryptographic functions 700 of FIG. 7A. The lattice setup procedure 742 receives configuration parameters and outputs a public configuration parameter for lattice digital signature scheme. The lattice key generating procedure 744 receives a public configuration parameter and outputs key data comprising a verification key and a signing key. It should be noted that in implementations the lattice key generating procedure 744 may not be used in the example cryptographic functions of FIG. 7A and may be replaced with the modified key generating procedure 752 in FIG. 7D. The lattice signature procedure 746 receives a public configuration parameter, a signing key and a message, and outputs lattice signature data. The lattice verification procedure 748 receives a public configuration parameter, a verification key, a message and lattice signature data, (e.g. in a similar form as output by the lattice signature procedure 746) and returns a verification indication (e.g. verified or not).

The example cryptographic functions 750 of FIG. 7D comprise a modified key generating procedure 752 (which may be referred to as a simple key generation process), a verification procedure 754, a signing key encoding procedure 756, and a simulator procedure 758. The example cryptographic functions 750 of FIG. 7D may be used to implement indicated sub-functions that form part of the example cryptographic functions 700 of FIG. 7A. The modified key generating procedure 752 receives a configuration parameter and a signing key, and outputs a verification key. The verification procedure 754 receives a public configuration parameter, a verification key and a difference metric, and returns a reconstructed verification key. The signing key encoding procedure 756 receives a public configuration parameter and a signing key, and outputs an encoded signing key. The simulator procedure 758 receives a public configuration parameter, the encoded signing key, and multiple difference metrics and outputs a reconstructed verification key and key components. The signing key encoding procedure 756 and the simulator procedure 758 may be used as part of cryptographic procedures that are associated with the generic fuzzy signature scheme.

Certain examples described herein allow a user to use noisy biometric data to generate verifiable digital signatures. This may avoid the need for dongles, smartcards or dedicated devices. A user may then scan a part of their body to generate a source of fuzzy data, that may be used in the cryptographic methods and systems described herein. In certain examples, a fuzzy digital signature scheme is provided that is secure against attack by a quantum computer. Hence, a user may authenticate themselves using biometric data in a manner that is post-quantum secure.

In certain examples, a fuzzy digital signature scheme that uses linear sketches is configured to operate with a lattice instantiation of a digital signature scheme. This is not straightforward. For example, it is not obvious how to incorporate the “noise” that is used in the latter lattice-based schemes within the former fuzzy digital signature schemes. Lattice-based schemes such as LWE use a noise term to generate a verification key; if a fuzzy key is used as a signing key there are in-effect two sources of “noise”—the fuzzy data and the noise term. This causes comparative fuzzy digital signature schemes to fail. Certain digital signature examples described herein provide compatibility by configuring a property of weak homomorphism and verification key simulatability. If a threshold for weak homomorphism is greater than zero, the verification key simulatability may be parameterised by a parameter Q, i.e. may display Q-verification key simulatability. The weak homomorphism may be achieved by defining a “closeness” measure for a verification key generated in the presence of variation. The examples described herein may be seen to be secure with respect to a signing-key encoding algorithm. Certain examples also provide simple key generation process, where a verification key may be generated given a signing key sampled uniformly from a defined signing key space. In this case, a verification key generated by a key generation process has the same (data) distribution whether or not a signing key is passed to the process (e.g. the key generation process may just use a configuration parameter). Digital signature schemes that are implemented according to the examples described herein may demonstrate a version of related-key attack security known as encoded signing-key related-key attack security. The “hardness” of a lattice-based approach may allow security even against quantum computer attacks.

Certain examples may thus comprise cryptographic systems that implement a lattice-based fuzzy digital signature scheme, where the lattice-based fuzzy digital signature scheme is β-weakly homomorphic and Q-verification key simulatable, and where β is greater than 0. Certain examples combine linear sketch and lattice-based approaches by viewing a signing key space of a digital signature scheme as [symbol] _{q}ⁿ when considering the linear sketch, the signing key space is thus a natural coefficient embedding of [symbol] _{q} to [symbol] _{q}ⁿ (which is an isomorphism). These systems may be used for verifying messages, data integrity and/or as an authentication mechanism.

Certain examples described herein feature a key generation operation that is not deterministic, e.g. that may be seen as a randomized function that samples from a distribution. This then requires adaptations to verifying operations as verification keys for a common user may vary with signing operations (i.e. may vary with each key generation operation). It is further noted that the presently described signing operations do not take an initialisation-time verification key as an input; indeed, this may make the digital signature scheme insecure.

Certain system components and methods described herein may be implemented by way of computer program code that is storable on a non-transitory storage medium, e.g. as described with reference to FIG. 4D. The above examples are to be understood as illustrative. Further examples are envisaged. Although certain components of each example have been separately described, it is to be understood that functionality described with reference to one example may be suitably implemented in another example, and that certain components may be omitted depending on the implementation. It is to be understood that any feature described in relation to any one example may be used alone, or in combination with other features described, and may also be used in combination with one or more features of any other of the examples; or any, combination of any other of the examples. For example, features described with respect to the system components may also be adapted to be performed as part of the described methods. Furthermore, equivalents and modifications not described above may also be employed without departing from the scope of the invention, which is defined in the accompanying claims.

1. A cryptographic system comprising:
a signature engine to digitally sign a message using fuzzy data associated with a signee, the signature engine being configured to generate a digital signature using a lattice instantiation and a linear sketch, the linear sketch being configured based on the lattice instantiation, the digital signature being a function of the fuzzy data and the message, the digital signature using a signature-time signing key residing within a signing key space, the signing key space being a space defined by the lattice instantiation, the digital signature comprising a signature-time verification key; and
a verification engine to receive the message and the digital signature and to verify the message as signed by the signee, the verification engine being configured to obtain key data for the signee comprising at least an initialisation-time verification key, to compute a distance metric based on the key data and the received digital signature, the distance metric indicating a measure of difference for the signature-time verification key, and to indicate a verification failure responsive to the distance metric being greater than a predefined homomorphic threshold.

2. A cryptographic system comprising:
a signing device comprising:
a fuzzy data interface to receive fuzzy data associated with a signee;
a message interface to receive a message for the signee to digitally sign;
a key generator to generate a signature-time signing key and a signature-time verification key, the signature-time signing key being generated to reside within a signing key space;
a lattice-compatible linear sketch generator to generate a linear sketch, the linear sketch comprising a function of the fuzzy data and the signature-time signing key, wherein the fuzzy data is used as an encoding key in the linear sketch to encode the signature-time signing key;
a lattice signature generator to receive the message and the signature-time signing key and to generate a lattice digital signature sigma for the message using the signature-time signing key, wherein the lattice digital signature sigma is generated using a lattice instantiation and the signing key space is a space defined by the lattice instantiation; and
an output interface to output a digital signature comprising the lattice digital signature sigma, the linear sketch and the signature-time verification key,
wherein the digital signature is verifiable using an initialisation-time verification key that varies from the signature-time verification key, wherein a variation of the signature-time verification key is comparable to a predefined homomorphic threshold.

3. A cryptographic system comprising:
a verification device comprising:
a message interface to receive a message to verify as being digitally signed by a signee;
a digital signature interface to receive a digital signature, the digital signature comprising a lattice digital signature sigma, a signature-time verification key for the signee and a linear sketch, the lattice digital signature sigma being generated using the signature-time signing key, the linear sketch being generated based on fuzzy data associated with the signee, the lattice digital signature sigma being generated based on a lattice instantiation and the linear sketch being generated using a linear sketch function compatible with the lattice instantiation;
a key data interface to receive key data comprising at least an initialisation-time verification key for the signee, wherein the initialisation-time verification key and the signature-time verification key are both generated using signing keys that reside in a signing key space defined by the lattice instantiation;
a verification engine communicatively coupled to the message interface, the digital signature interface, and the key data interface to respectively receive the message, the digital signature and the key data, the verification engine being configured to:
generate a reconstructed verification key from the linear sketch and the key data;
compute a distance metric indicating a measure of difference between the signature-time verification key and the reconstructed verification key; and
verify the digital signature based on at least the computed distance metric, and
an output interface to output a result from the verification engine.

4. The cryptographic system of claim 1, wherein the verification engine is configured to:
perform a verification of the lattice digital signature sigma using the signature-time verification key and the message, the verification being made according to the lattice instantiation,
wherein the digital signature is verified based on at least the computed distance metric and an output of the verification.

5. The cryptographic system of claim 1, comprising:
a key generator to generate the key data for the signee, the key generator being configured to:
generate an initialisation-time signing key, the initialisation-time signing key residing within the signing key space; and
generate the initialisation-time verification key as a function of the initialisation-time signing key and a noise term that is sampled from a defined noise distribution.

6. The cryptographic system of claim 1, wherein the fuzzy data comprises biometric data.

7. The cryptographic system of claim 1, wherein the lattice instantiation comprises a Learning With Errors (LWE) instantiation.

8. The cryptographic system of claim 7, wherein the lattice instantiation comprises a Ring Learning With Errors (Ring-LWE) instantiation, wherein the signing key space comprises the ring of the Ring-LWE instantiation.

9. The cryptographic system of claim 1, wherein each verification key from the group of the initialisation-time verification key and the signature-time verification key is a function of a signing key, a configuration parameter and a noise term that is sampled from a defined noise distribution, the configuration parameter being selected based on the signing key space.

10. The cryptographic system of claim 1, wherein the cryptographic system is configured using one or more of the following parameters:
a lattice dimension for the lattice instantiation;
the predefined homomorphic threshold;
a modulus size used to define the signing key space; and
a number of values to compute for the linear sketch.

11. The cryptographic system of claim 1, wherein the linear sketch is computed using a hash function that outputs values that are within the signing key space.

12. The cryptographic system of claim 1, wherein the fuzzy data comprises a fixed-length binary data sequence.

13. The cryptographic system of claim 1, wherein the initialisation-time verification key and the signature-time verification key are public keys and the signature-time signing key is a private key.

14. The cryptographic system of claim 1, comprising:
a first terminal comprising the signature engine;
a second terminal comprising the verification engine; and
a communications channel to communicatively couple the first terminal and the second terminal.

15. The cryptographic system of claim 1, wherein the signing engine is configured to sample the signature-time signing key from the signing key space and to generate the signature-time verification key as a function of the signature-time signing key and a noise term that is sampled from a defined noise distribution, wherein the lattice digital signature sigma is generated using a further noise term that is sampled from the defined noise distribution.

16. The cryptographic system of claim 4, wherein the verification engine is configured to perform a verification of the lattice digital signature sigma by comparing a noise term of the lattice digital signature sigma with a variance threshold and to indicate a verification failure response to the variance threshold being exceeded.

17-33. (canceled)

34. A cryptographic system implementing a lattice-based fuzzy digital signature scheme, the lattice-based fuzzy digital signature scheme being β-weakly homomorphic and Q-verification key simulatable, where β is greater than 0.

35-37. (canceled)

38. The cryptographic system of claim 2, comprising:
a key generator to generate the key data for the signee, the key generator being configured to:
generate an initialisation-time signing key, the initialisation-time signing key residing within the signing key space; and
generate the initialisation-time verification key as a function of the initialisation-time signing key and a noise term that is sampled from a defined noise distribution.

39. The cryptographic system of claim 3, comprising:
a key generator to generate the key data for the signee, the key generator being configured to:
generate an initialisation-time signing key, the initialisation-time signing key residing within the signing key space; and
generate the initialisation-time verification key as a function of the initialisation-time signing key and a noise term that is sampled from a defined noise distribution.
